(19) United States
(12) Patent Application Publication
(10) Pub. No.: US 2026/0032463 A1
(43) Pub. Date: Jan. 29, 2026

(54) NETWORK ENTITY CONFIGURATIONS FOR TRAINING AND INFERENCE OF MACHINE LEARNING FUNCTIONS

(71) Applicant: Qualcomm Incorporated, San Diego, CA (US)

(72) Inventors: Rajeev KUMAR, San Diego, CA (US); Hamed PEZESHKI, San Diego, CA (US); Aziz GHOLMIEH, Del Mar, CA (US); Taesang YOO, San Diego, CA (US)

(21) Appl. No.: 18/786,313

(22) Filed: Jul. 26, 2024

(51) Int. Cl. H04W 24/02

(52) U.S. Cl. CPC H04W 24/02

(57) ABSTRACT

Certain aspects of the present disclosure provide techniques for communication of network entity-specific configurations for machine learning training and/or inference. An example method for wireless communications by an apparatus includes obtaining a first request for an indication of at least one configuration for use at one or more first network entities during one or more machine learning operations associated with one or more machine learning functions available for activation at a user equipment (UE); sending, to the UE, an indication of a first association between the at least one configuration and at least one machine learning function of the one or more machine learning functions; and communicating with the UE while using the at least one configuration.

### FIELD OF THE DISCLOSURE

Aspects of the present disclosure relate to wireless communications, and more particularly, to techniques for communication of network entity configurations for training and inference of machine learning functions.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining a first request for an indication of at least one configuration for use at one or more first network entities during one or more machine learning operations associated with one or more machine learning functions available for activation at a user equipment (UE); sending, to the UE, an indication of a first association between the at least one configuration and at least one machine learning function of the one or more machine learning functions; and communicating with the UE while using the at least one configuration.

Another aspect provides a method for wireless communications by an apparatus. The method includes sending a first request for an indication of at least one configuration for use at one or more first network entities during one or more machine learning operations associated with one or more machine learning functions available for activation at the apparatus; obtaining an indication of a first association between at least one configuration and at least one machine learning function of the one or more machine learning functions; and communicating, while using a machine learning model associated with the at least one machine learning function, with a network entity of the one or more first network entities.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts example beam prediction by a UE.

FIG. 6 depicts an example of UE mobility in a wireless communications network.

FIG. 7 depicts an example scheme for multi-network entity machine learning configuration(s).

FIG. 8 depicts a process flow for signaling network entity-specific configurations for training and inference.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for communication of network entity-specific configurations for machine learning training and/or inference.

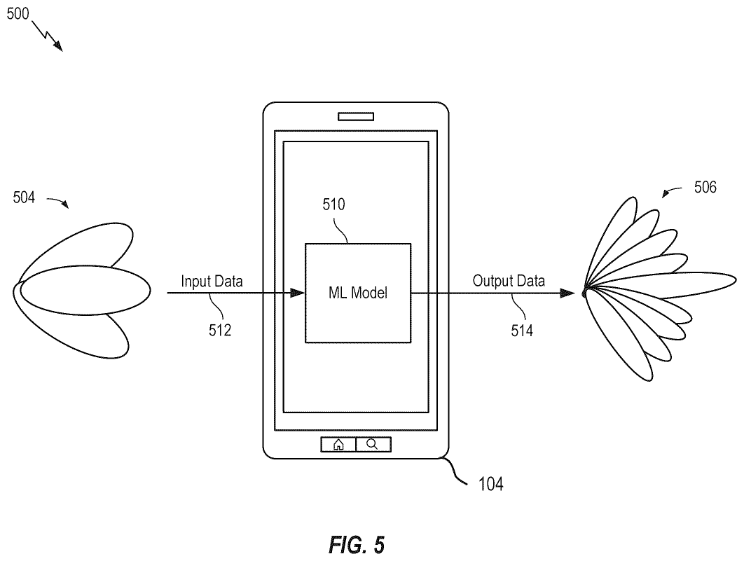

Certain wireless communications systems (e.g., a 5G New Radio (NR) system and/or any future wireless communications system) may employ artificial intelligence (AI) to perform various operations, such as channel state information (CSI) estimation and/or prediction, CSI compression and/or decompression (e.g., CSI encoding and/or decoding), beam management, device positioning, user equipment (UE) mobility management, or the like. In certain cases, these operations may be referred to as functions, features, feature groups, use cases, or sub-use cases for AI-aided wireless communications. As an example of certain use case(s) for beam prediction, the UE may use a machine learning (ML) model to determine temporal and/or spatial beam prediction(s) for a set of A-beams based on measurement results of a set of B-beams, as further described herein with respect to FIG. 5. For example, the set of B-beams may include one or more wide beams, and the set of A-beams may include one or more narrow beams within the radiation pattern of the set of B-beams.

Technical problems for AI-aided wireless communications may include, for example, effective life cycle management of UE-deployed ML models for communications across multiple network entities, for example, due to beam switches, cell switches, and/or handovers between network entities related to UE mobility. For a UE-deployed ML model, the UE may obtain, from a network entity (e.g., a base station) a data collection configuration and/or an associated identifier. The data collection configuration and/or associated identifier may indicate the data to use for training and/or inference operations for the ML model. The data collection configuration and/or associated identifier may indicate certain network entity-specific configuration(s) (such as a precoding configuration used at the network entity, an antenna configuration used at the network entity, a location of the network entity, or the like) for application of the ML model, for example, in terms of training and/or inference operations. In certain cases, the configuration(s) associated with the ML model may be specific to a network entity and/or cell thereof.

The UE may obtain the data corresponding to the data collection configuration and the UE may train and/or update the ML model based on the data. As an example, in order to train an ML model for spatial-domain beam predictions, the UE may obtain radio measurement(s) associated with the set of A-beams and the set of B-beams to train the spatial relationship between the set of A-beams and the set of B-beams. The UE may send, to the network entity, an indication that the ML model is trained and/or available for AI-aided wireless communications, such as beam predictions or the like. The UE may obtain, from the network entity, an indication to use the ML model for AI-aided wireless communications, for example, based on the associated identifier.

However, for certain wireless communications systems (e.g., 5G NR systems or the like), it may not be established how to determine and/or configure the identifier(s) associated with the configuration applied across multiple network entities in a wireless communications system. Accordingly, as the UE may communicate with multiple network entities across multiple beams and/or cells over time (e.g., due to UE mobility), the UE and a given network entity may not be aligned on the relationship between the identifier(s) and/or the network-entity specific configurations(s) for application of one or more ML models for a specific beam, cell, and/or network entity.

Aspects described herein may overcome the aforementioned technical problem(s), for example, by providing schemes for communication of certain configuration(s) (e.g., network entity-specific configuration(s)) for application of AI-aided wireless communications, such as certain training and/or inference operations of UE-deployed ML model(s). In certain aspects, a UE may obtain an indication of an association between certain configuration(s) of a network entity and a machine learning function, such as CSI compression, beam management, or the like. In certain cases, an indication of the association may be or include certain identifiers (e.g., the associated identifiers discussed above) that map data collection configuration(s), for training and/or inference operations, to certain ML model(s) and/or ML function(s). As an example, for AI-aided beam predictions, a data collection configuration and/or the associated identifier may indicate a set of A-beams and/or a set of B-beams associated with a cell served by a specific network entity. In certain cases, the set of network entity-specific configuration(s) may include a precoding configuration, antenna configuration, or the like. In certain cases, the network entity-specific configuration(s) associated with the ML model may be unknown to the UE, such as load balancing conditions, channel usage, channel capacity, power consumption at the network entity, or the like.

In certain aspects, data collection configurations and/or associated identifiers may be shared among network entities to allow the UE to obtain, from a network entity, an indication of the network entity-specific configuration(s) associated with another network entity. As an example, a first network entity may obtain from a second network entity the identifiers used by the second network entity to indicate the condition(s) for application of AI-aided wireless communications with the second network entity. The UE may obtain, from the first network entity, an indication of the network entity-specific condition(s) for application of AI-aided wireless communications with the first network entity and/or the second network entity.

Certain techniques for communication of network entity-specific configuration(s) described herein may provide various beneficial technical effects and/or advantages. The techniques for communication of network entity-specific configuration(s) may enable improved wireless communications performance, such as reduced latencies, reduced interruption times, improved accuracy, and/or improved reliability in terms of UE-deployed ML models. The reduced latencies and/or reduced interruption times may be attributable to a UE obtaining an indication of network entity-specific configurations for multiple network entities. As an example, as the UE moves among coverage areas of multiple network entities over time, the UE may reduce the latencies and/or interruption times in terms of model training and inference associated with a UE-deployed ML model, for example, due to the UE being aware of which UE-deployed ML model to use for any given network entity. The improved accuracy and/or improved reliability of a UE-deployed ML model may be attributable to the UE being able to train and perform inference operations under the network entity-specific configuration(s) expected for communications with any given network entity.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

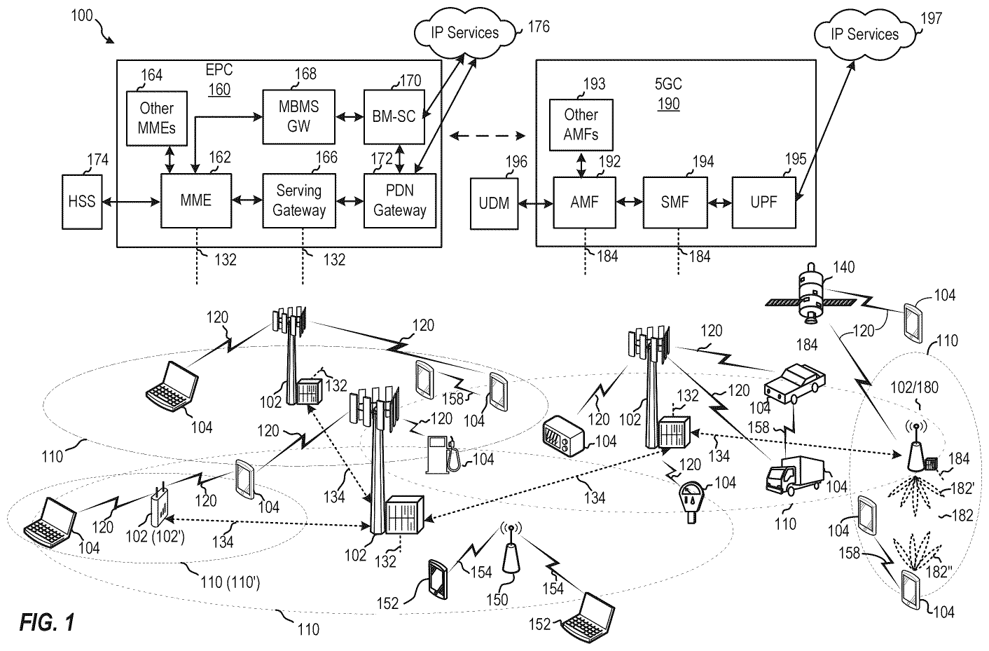

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or acrial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

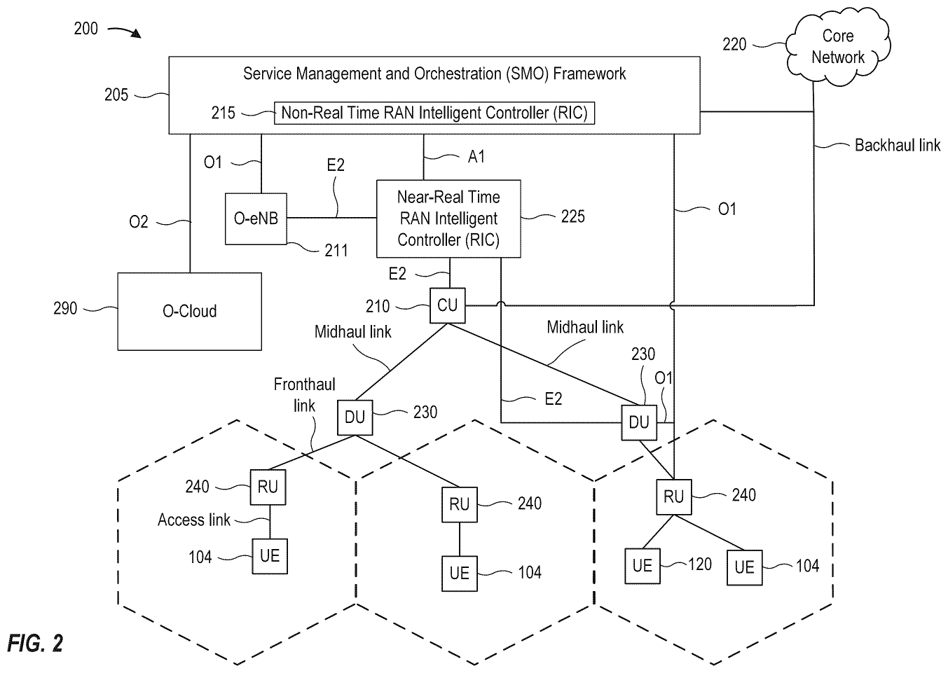

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

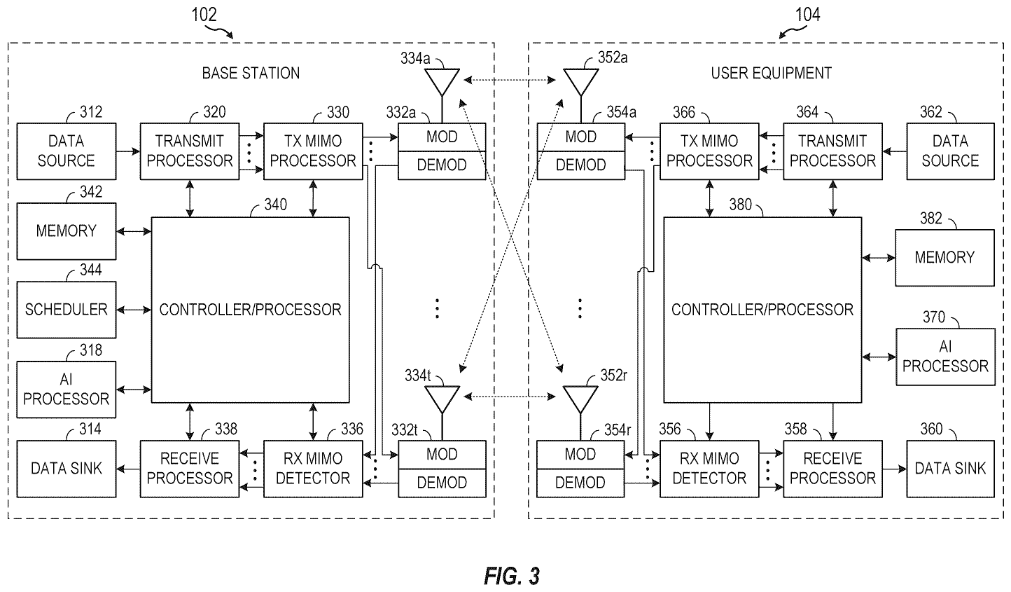

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

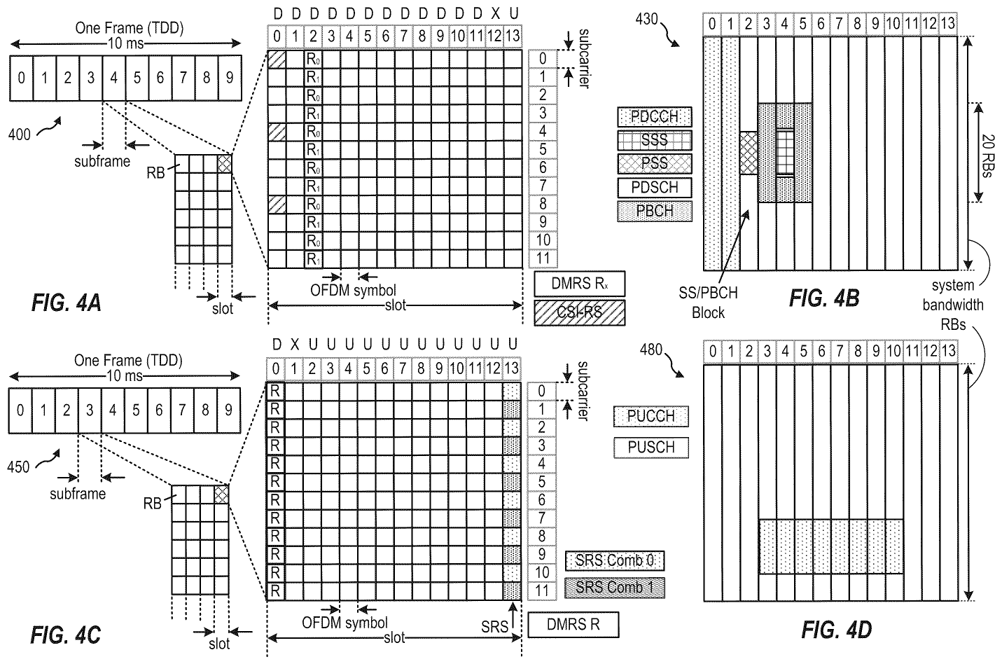

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for both DL and UL. Wireless communications frame structures may also be time division duplex (TDD), in which, for a particular set of subcarriers, subframes within the set of subcarriers are dedicated for either DL or UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Artificial Intelligence-Aided Beam Management Procedures

Certain aspects described herein may be implemented, at least in part, using some form of AI, e.g., the process of using a ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

Aspects of the present disclosure may describe the performance of certain tasks and the technical solution of various technical problems by application of a specific type of ML model, such as an artificial neural network (ANN). It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that terms such as “AI model,” “ML model,” “AI/ML model,” “trained ML model,” and the like may be interchangeable.

AI/ML techniques have been introduced to help reduce the complexity involved in beam selection and the overhead associated with beam management without sacrificing system performance. For example, with the help of ML techniques, beam selection may be performed in a fraction of the time taken by conventional exhaustive search methods and with performance comparable to that of such methods.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or any other uniformly spaced array).

In certain aspects, an ML model is deployed at or on a UE (e.g., such as UE 104 in FIG. 1), for example, for purposes of spatial domain (SD), temporal domain (TD), and/or frequency domain (FD) beam prediction. The TD refers to the analytic space in which signals are conveyed in terms of time, rather than frequency. The FD refers to the analytic space in which signals are conveyed in terms of frequency, rather than time. A scenario where the ML model, at or on the UE, is used to predict SD downlink beams for a set of A-beams based on measurement results of a set of B-beams may be referred to as a beam management case 1, or simply “BM-Case1.” Additionally, a scenario where the ML model, at or on the UE, is used to predict TD downlink beams for a set of A-beams based on the historic measurement results of a set of B-beams may be referred to as a beam management case 2, or simply “BM-Case2.” In general, ML may be used to predict characteristics associated with the set of A-beams, and the set of B-beams may be used for DL beam measurements as input data for the ML. For BM-Casel and BM-Case2, the beams in the set of A-beams and the set of B-beams may be in the same Frequency Range (e.g., FR1 and/or FR2). In some cases, the set of B-beams may be a subset of the set of A-beams. There may be any number of beams in each of the set of A-beams and the set of B-beams. There may be quasi-colocation (QCL) relationships between the set of A-beams and the set of B-beams.

FIG. 5 is a diagram illustrating example beam prediction 500 by a UE 104. In this example, an ML model 510 is deployed at or on UE 104 to enable UE 104 to make one or more beam predictions based on data input to ML model 510.

For example, a network entity (e.g., a base station or any disaggregated entity thereof) may transmit one or more signals (e.g., SSB(s), DM-RS(s), CSI-RS(s)), via a first set of transmit beams 504, in a first set of communication resources (e.g., an SSB resource, a DM-RS resource, and/or a CSI-RS resource). The UE 104 may perform measurements (e.g., L1-RSRP measurements and/or other measurements) of the one or more signals transmitted in the first set of communication resources, or a subset thereof, to obtain input data, which may include a first set of measurements 512 (sometimes referred to as parameters, channel characteristics, or channel properties). For example, each transmit beam (or a subset thereof), from the first set of transmit beams 504 carrying the one or more signals, may be associated with one or more measurements 512 performed by UE 104. UE 104 may feed the first set of measurements 512 (e.g., L1 RSRP measurement values) into the ML model 510. The UE 104 may further feed information associated with the first set of transmit beams 504 and/or first set of communication resources (or a subset thereof). The information associated with the first set of transmit beams 504 may include a beam direction (e.g., a spatial direction), beam width, beam shape, and/or other characteristics of the respective beam.

The ML model 510 may provide output data, for example, including one or more predictions. More specifically, ML model 510 may provide one or more predicted measurement values 514 for a second set of communication resources associated with a second set of transmit beams 506. The one or more predicted measurement values 514 may include predicted channel characteristics (e.g., predicted L1-RSRP measurement values) associated with the second set of communication resources, where the second set of communication resources are associated with the second set of transmit beams 506.

In some examples, the first set of transmit beams 504 (e.g., that are measured) may be referred to as “the set of B-beams” or “Set B beams” and the second set of transmit beams 506 (e.g., that are associated with predicted measurements for the second set of communication resources) may be referred to as “the set of A-beams” or “Set A beams.” Put another way, the “Set B beams” are a set of beams for which measurements are taken and used to determine input data based on such measurements for the ML model 510, whereas the “Set A beams” are a set of beams for which ML model 510 performs predictions.

In some examples, the first set of transmit beams 504 are a subset of the second set of transmit beams 506. In some other examples, first set of transmit beams 504 and second set of transmit beams 506 are different beams and/or may be mutually exclusive sets. For example, the first set of transmit beams 504 may include wide beams (e.g., unrefined beams or beams having a beam width that satisfies a first threshold), and the second set of transmit beams 506 may include narrow beams (e.g., refined beams or beams having a beam width that satisfies a second threshold).

Use of the ML model 510 for beam prediction may reduce a quantity of beam measurements that are performed by UE 104 (e.g., compared to exhaustive transmit and receive beam search methods), thereby conserving power at UE 104 and/or network resources that would have otherwise been used to measure all beams included in at least the first set of transmit beams 504.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the ML model 510 may include a point-direction, an angle of departure (AoD), and/or an angle of arrival (AoA) of a beam included in the second set of transmit beams 506. This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to ML model 510. This may enable ML model 510 to output codebook-based and/or non-codebook-based predictions for a measurement value, an AoD, and/or an AoA, among other examples, of a beam at a future time. The output(s) of ML model 510, may facilitate initial access procedures, carrier aggregation (e.g., secondary cell setup), dual connectivity (e.g., secondary cell group (SCG) setup), beam refinement procedures (e.g., a P2 beam management procedure and/or a P3 beam management procedure), link quality or interference adaptation procedures, beam failure and/or beam blockage predictions, and/or radio link failure predictions, among other examples.

In certain aspects, an output of ML model 510 may include a temporal beam prediction. The TD beam prediction may be associated with a serving beam refinement, a link quality (e.g., CQI or PMI) and interference adaptation, a beam failure/blockage prediction, and/or a radio link failure (RLF) prediction.

In certain aspects, ML model 510 performs SD downlink beam predictions for beams included in the second set of transmit beams 506 based on measurement results of beams included in the first set of transmit beams 504. In some aspects, ML model 510 performs TD downlink beam prediction for beams included in the second set of transmit beams 506 based on historic measurement results of beams included in the first set of transmit beams 504.

Note that AI-aided beam prediction as described herein with respect to FIG. 5 is an example of AI-aided wireless communications. Aspects of the present disclosure may be applied to any other suitable AI/ML functions for wireless communications, such as CSI estimation and/or prediction, CSI compression and/or decompression (e.g., CSI encoding and/or decoding), data or signaling compression and/or decompression, device positioning (e.g., UE positioning and/or TRP positioning), UE mobility management, and/or the like.

### Example Mobility Management

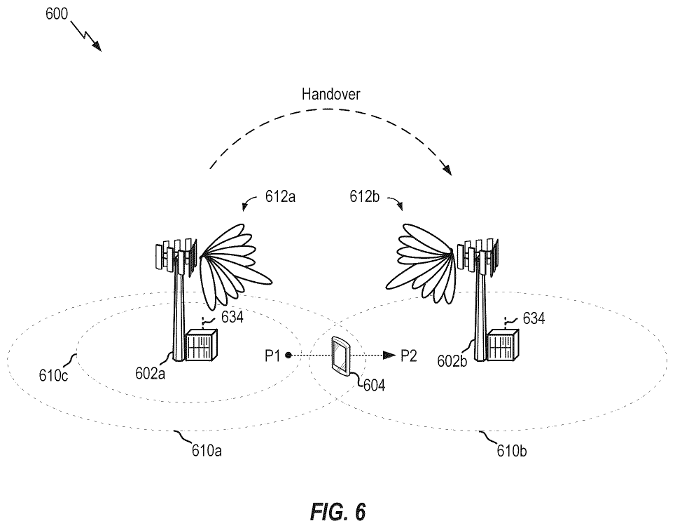

FIG. 6 depicts an example of UE mobility in a wireless communications network 600. In this example, the wireless communications network 600 may include a first network entity 602a having a first coverage area 610a and a second network entity 602b having a second coverage area 610b, which may overlap with the first coverage area 610a. The first network entity 602a may also have a third coverage area 610c. In certain aspects, the first coverage area 610a may form a first cell, the second coverage area 610b may form a second cell, and the third coverage area 610c may form a third cell. The first cell and third cell may form a first cell group, and the second cell may form a second cell group. The first network entity 602a may communicate via a first set of beams 612a, and the second network entity 602b may communicate via a second set of beams 612b.

Due to mobility (e.g., a UE 604 moving from the first coverage area 610a to the second coverage area 610b), the UE 604 may transition from communicating with the first network entity 602a via the first set of beams 612a to communicating with the second network entity 602b via the second set of beams 612b. As an example, the UE 604 may be located at a first position P1 in the first coverage area 610a and/or the third coverage area 610c at a first occasion, and then the UE 604 may move to a second position P2 in the second coverage area 610b at a second, later occasion.

In some cases, the UE 604 may send a measurement report to the first network entity 602a. For example, the first network entity 602a may configure the UE 604 to measure a set of neighboring cell(s) and/or beam(s) of one or more neighboring network entities (e.g., the second network entity 602b). In some cases, the UE 604 may identify neighboring cell(s) and/or beam(s) of a neighboring network entity, for example, via signaling transmitted by the neighboring network entity. The neighboring cell(s) and/or beam(s) may be or include candidate communication link(s) that the UE can handover or switch to from the cell(s) and/or beam(s) of the first network entity 602a. As an example, the neighboring cell(s) and/or beam(s) may include the second cell of the second coverage area 610b and/or the second set of beams 612b. The measurement report may indicate radio measurements (e.g., signal strengths) associated with the serving cell of the first network entity 602a and/or neighboring cell(s), such as the cell(s) of the second network entity 602b. In certain cases, the measurement report may indicate the signal strengths associated with certain beam(s) of the serving cell and the neighboring cell(s), such as the first set of beams 612a and/or the second set of beams 612b. Based on the measurement report (e.g., indicating a stronger signal strength associated with radio measurements for the second network entity 602b relative to the first network entity 602a), the first network entity 602a may determine to handover (HO) communications with the UE 604 to the second network entity 602b. The first network entity 602a may be in communication with the second network entity 602b via a backhaul link 634 (e.g., an F1, Xn, and/or NG interface) in order to exchange information for the handover.

In the context of a handover or mobility operation, the first network entity 602a may be referred to as a source network entity; and the second network entity 602b may be referred to as a target, candidate, neighbor, or neighboring network entity, depending on the stage of the handover or mobility operation. As part of a handover, the source network entity transfers a connection with a UE to a target network entity. A candidate or neighboring network entity may be a possible target for the handover, and in some cases, the candidate or neighboring network entity may communicate via candidate cell(s) and/or beam(s) having coverage area(s) adjacent to or overlapping with the coverage area(s) of the source network entity.

In some cases, the handover may involve a CU/DU handover, such as inter-DU-intra-CU handover and/or inter-CU handover, for example, as described herein with respect to FIG. 2. For example, the handover may involve a handover from a source DU to a target or candidate DU in communication with a common CU (e.g., inter-DU-intra-CU handover). In some cases, the handover may involve a handover from a source CU to a target or candidate CU (e.g., inter-CU handover). Accordingly, the first network entity 602a and/or the second network entity 602b may be an example of an RU, DU, and/or CU.

Note that the handover illustrated in FIG. 6 is an example of a mobility operation. Aspects of the present disclosure described herein may be applied to various types of UE mobility operations including, for example, (conditional) lower-layer triggered mobility (LTM), L3 mobility, an Xn based handover, an N2 based handover, conditional handover, beam selection, beam switch, (conditional) serving cell modification or change, (conditional) serving cell addition, (conditional) serving cell release, cell group modification, cell group addition, cell group release, dual active protocol stack (DAPS) handover, dual connectivity, or the like. A mobility operation or handover may be triggered, for example, due to radio conditions (e.g., in response to a measurement report), load balancing at a network entity, and/or a specific service (e.g., certain QoS specification(s) for communications are satisfied).

### Aspects Related to Communication of Network Entity-Specific Configurations for Training and Inference

Aspects of the present disclosure provide schemes for communication of certain configuration(s) (e.g., network entity-specific configuration(s)) for application of AI-aided wireless communications, such as certain training and/or inference operations of UE-deployed ML model(s).

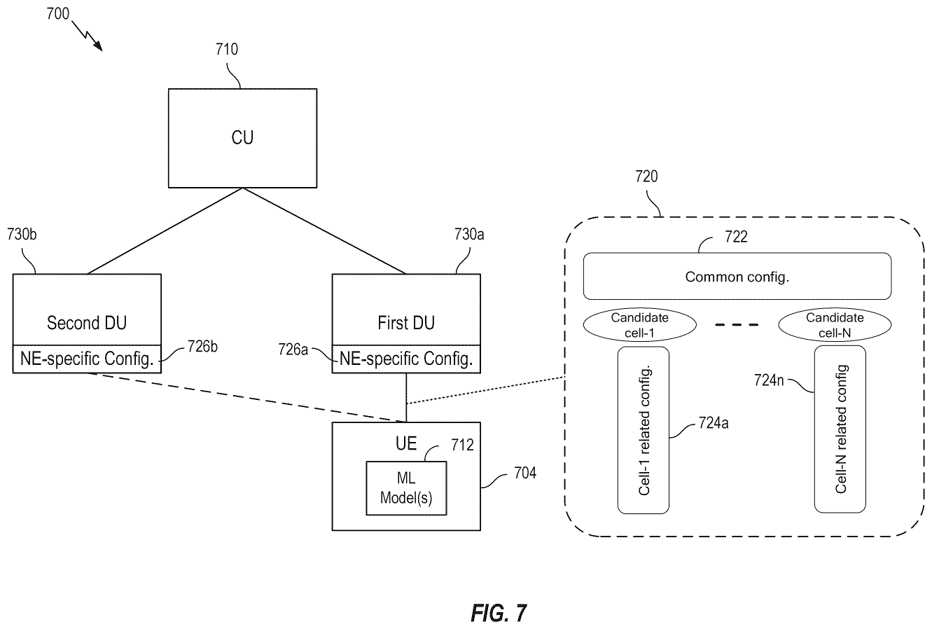

FIG. 7 depicts an example scheme 700 for multi-network entity ML configuration(s). In this example, a UE 702 may be in communication with a first DU 730a, which may be a source DU, for example, as described herein with respect to FIG. 6. The UE 704 may be capable of performing one or more ML functions via one or more UE-deployed ML models 712. The one or more ML functions (features and/or feature groups) may be or include any suitable AI-based function or operation for wireless communications, such as CSI estimation and/or prediction, CSI compression and/or decompression, data or signaling compression and/or decompression, beam management, UE or device positioning, UE mobility management, and/or the like. Accordingly, the one or more ML functions may be available for training, activation, and/or deactivation at the UE 704. For example, the one or more ML models 712 may be deployed (or capable of being deployed) at the UE 704 for AI-aided wireless communications that enable any of the ML function(s) discussed herein.

A CU 710 may be in communication with the first DU 730a and a second DU 730b, and the second DU 730b may be a candidate or neighboring DU, for example, as described herein with respect to FIG. 6. The CU 710 may obtain, from the first DU 730a, a first set of ML function configurations associated with the cell(s) served by the first DU 730a. The CU 710 may obtain, from the second DU 730b, a second set of ML function configurations associated with the cell(s) served by the second DU 730b. The CU 710 may send, to the first DU 730a, the second set of ML function configurations; and the CU 710 may send, to the second DU 730b, the first set of ML function configurations. Each of the first DU 730a and the second DU 730b may generate a multi-network entity ML configuration 720 based on the first set of ML function configurations and/or the second set of ML function configurations.

The first set of ML function configurations and/or the second set of ML function configurations may include one or more data collection configurations for training a ML model (such as the one or more ML models 712) and/or one or more inference configurations for inference operations of the ML model. As an example, a data collection configuration may indicate the training data (such as certain radio measurement(s) for beam predictions) to obtain for training the ML model.

ML model training may include offline model training, online model training, federated learning, distributed model training, or any other suitable type of ML model training. In certain aspects, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE. Decentralized, distributed, or shared learning, such as federated learning, may enable training on data distributed across multiple devices or organizations, without the need to centralize data or the training.

The inference configuration may indicate the input data to provide an ML model for the interference operations. In certain aspects, the inference configuration may indicate the output data to estimate or predict using the ML model. Note that “inference operation(s)” or “inference” may refer to operationalization of a trained ML model. For example, an inference operation may include using the trained ML model to generate predictions, estimations, or the like. As another example, an inference operation may include using the trained ML model for compression and/or decompression, for example, of CSI and/or any other suitable payload communicated between a UE and a network entity.

In certain aspects, the UE 704 may obtain, from the first DU 730a or the second DU 730b, the multi-network entity ML configuration 720, which may be formed based on the first set of ML function configurations and/or the second set of ML function configurations. The multi-network entity ML configuration 720 may include a common configuration 722 and one or more cell-specific configurations 724a, 724n. The common configuration 722 may indicate or include one or more common or shared parameters that may apply to AI-aided wireless communications with the first DU 730a and the second DU 730b, such as a reference configuration, a cell-to-identifier mapping, an LTM CSI resource configuration, or the like. The reference configuration may indicate or include common RRC information, such as system information and/or a RRC reconfiguration message.

The reference configuration may indicate or include a set of parameters that is common among multiple network entities and/or cells served by or at one or more network entities, such as the first DU 730a and the second DU 730b. As an example, the reference configuration may be or include a subset of parameters for an RRC reconfiguration message. In certain cases, the subset of parameters for the RRC reconfiguration message may be or include common parameter(s) for data collection configuration(s) and/or inference configuration(s) associated with one or more ML functions. In certain aspects, the common configuration 722 may be or include a location-independent configuration that can be applied to communicate with multiple network entities of a wireless communications system. The common configuration 722 may be used for communications with any of the first DU 730a, the second DU 730b, and/or the CU 710.

Each of the one or more cell-specific configurations 724a, 724n may indicate or include one or more cell-specific parameters for AI-aided wireless communications, such as a RRC configuration container (which may supplement or modify the reference configuration), a random access channel (RACH) configuration, an SSB configuration, transmission configuration indicator (TCI) state configuration, or the like. The cell-specific configurations 724a, 724n may indicate or include configurations for the cells served by the first DU 730a and the second DU 730b.

In certain aspects, a cell-specific configuration (e.g., 724a) may indicate or include cell-specific parameter(s) of one or more data collection configurations for training a UE-deployed ML model and/or one or more inference configurations for performing inference operations using the UE-deployed ML model. As an example, the cell-specific configuration 724a may indicate or include a data collection configuration for training beam predictions of a set of A-beams based on measurement results of a set of B-beams; and in certain cases, the cell-specific configuration 724a may indicate or include the inference configuration for beam predictions associated with the set of A-beams and the set of B-beams. Accordingly, the multi-network entity ML configuration 720 may enable the UE to perform AI-aided wireless communications across the coverage areas of multiple network entities, such as the first DU 730a and the second DU 730b, with reduced latencies, reduced interruption times, improved accuracy, and/or improved reliability.

Each of the one or more cell-specific configurations 724a, 724n may indicate or include an association between a network entity-specific configuration 726a, 726b for AI-aided wireless communications and one or more ML function configuration(s) (e.g., data collection configuration(s) and/or inference configuration(s)) associated with a specific ML function. In certain aspects, a cell-specific configuration (e.g., 724a) may indicate or include multiple associations for various network entity-specific configurations and/or various ML functions. The network entity-specific configuration 726a, 726b may be or include a configuration used at a network entity (such as the first DU 730a and/or the second DU 730b) during one or more ML operations (e.g., training and/or inference operation(s)) associated with an ML function available for activation at the UE 704. The one or more ML operations may be or include performing one or more inference operations and/or data collection of training data for ML model training.

As an example, the network entity-specific configuration 726a, 726b may be or include a precoding configuration (e.g., a codebook index) used at the network entity (e.g., the first DU 730a or the second DU 730b) during training and/or inference of a ML model used for beam prediction. In certain cases, the network entity-specific configuration 726a, 726b may be or include an antenna configuration of the respective network entity, a location of a transmission-reception point (TRP) of the respective network entity, an antenna port used for communications at the respective network entity, an antenna tilt for the respective network entity, or the like. In certain cases, an identifier may be used to indicate the association between the network entity-specific configuration and the ML function configuration(s) associated with a specific ML function. As an example, an associated identifier (hereinafter “associated ID”) may be used to indicate the association for ML model training and/or inference operations of a particular ML function, such as beam predictions.

The association between the network entity-specific configuration 726a, 726b and the ML function configuration(s) may enable the UE to be aware of which data collection configuration to use for ML model training and/or which inference configuration to use for inference operations depending on a particular network entity-specific configuration (such as different precoding configurations, different active antenna elements, or the like). As an example, the association between the network entity-specific configuration 726a, 726b and the cell-specific configuration 724a, 724n may indicate that a particular network entity-specific configuration (such as a precoding configuration) is expected to be used at or by a network entity during ML model training for a specific data collection configuration and/or inference operations for a specific inference configuration associated with an ML function (such as beam prediction). Accordingly, the association between the network entity-specific configuration and the ML function configuration may allow the UE and the network entity to be aligned during ML model training and/or inference operations for the UE-deployed ML model(s) depending on a particular state of the network entity (such as the network entity-specific configuration).

In certain aspects, a network entity (such as the first DU 730a or the second DU 730b) may send, to the UE 704, an indication of the association between the network entity-specific configuration 726a, 726b and a ML function configuration (such as a data collection configuration that indicates the set of A-beams and the set of B-beams for beam predictions) associated with training operations of a specific ML function. In certain cases, the association may be between the network entity-specific configuration 726a, 726b and an inference configuration for the ML function. In certain cases, the network entity may send, to the UE 704, the indication of the association proactively without a request from the UE 704. As an example, the network entity may send an indication of the association periodically, for example, with system information. The network entity may broadcast, multicast, and/or unicast the indication of the association. The network entity may send an indication of the association based on an AI/ML service (e.g., in response to an ML training server). In certain cases, the network entity may send an indication of the association depending on the geographic region of the coverage area served by the network entity.

In certain cases, the network entity may send, to the UE 704, the indication of the association in response to a request from the UE and/or another network entity (e.g., a DU, CU, AMF, or the like). For example, a data collection configuration and corresponding association (for a network-entity specific configuration) may be sent by the network entity upon UE request, for example, via on-demand system information (e.g., on-demand SIB).

### Example Signaling of Network Entity-Specific Configurations for Training and Inference

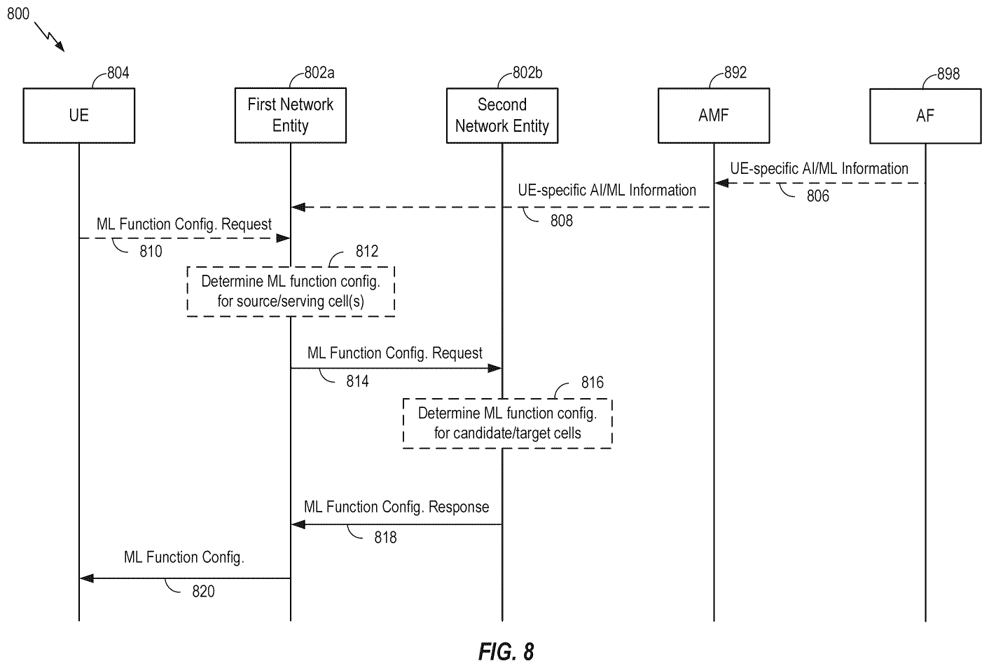

FIG. 8 depicts a process flow 800 for signaling network entity-specific configurations for training and inference in a system including a first network entity 802a, a second network entity 802b, a user equipment (UE) 804, an AMF 892, and an application function (AF) 898. In certain aspects, each of the network entities 802a, 802b may be an example of the BS 102 depicted and described with respect to FIGS. 1 and 3 or a disaggregated base station depicted and described with respect to FIG. 2. In certain cases, the first network entity 802a may be an example of a DU (e.g., the first DU of FIG. 7) and/or CU (e.g., the CU of FIG. 7), and the second network entity 802b may be an example of a DU (such as the second DU of FIG. 7). In certain cases, the first network entity 802a may be an example of a source network entity, and the second network entity may be an example of a candidate, neighboring, or target network entity, for example, as described herein with respect to FIG. 6. The AMF 892 may be an example of the AMF 192 of FIG. 1. The AF 898 may be an example of an application-specific network entity in a core network, such as the 5GC 190. As an example, the AF 898 may be or include a training server or service that provides access to one or more pre-trained ML models for certain UEs. Similarly, the UE 804 may be an example of UE 104 depicted and described with respect to FIGS. 1 and 3. However, in other aspects, UE 804 may be another type of wireless communications device, and the network entity 802a, 802b may be another type of network entity or network node, such as those described herein. Note that any operations or signaling illustrated with dashed lines may indicate that that operation or signaling is an optional or alternative example.

At 806, the AMF 892 optionally obtains, from the AF 898, first UE-specific AI/ML information. The UE-specific AI/ML information may indicate or include a UE identity, a user plane address, and/or one or more ML function capabilities associated with a particular UE, such as the UE 804. A ML function capability may indicate the ML function(s) available for activation, deactivation, and/or training at the UE 804.

At 808, the first network entity 802a optionally obtains, from the AMF 892, second UE-specific AI/ML information. The second UE-specific AI/ML information may be or include the first UE-specific AI/ML information. In certain cases, the second UE-specific AI/ML information may be communicated via a UE context setup or modification message, a UE connection establishment indication, a path switch request, or a UE AI/ML transport configuration. In certain aspects, the second UE-specific AI/ML information may be treated, at or by the first network entity 802a, as a request to send an association between a network entity-specific configuration and an ML function configuration as described herein with respect to FIG. 7. As an example, the second UE-specific AI/ML information may trigger the first network entity 802a to send the association to the UE 804 as further described herein.

At 810, the UE 804 optionally sends, to the first network entity 802a, a request for a ML function configuration and/or the association between a network entity-specific configuration and the ML function configuration. The ML function configuration may be or include a data collection configuration and/or an inference configuration for a ML function (such as beam management, CSI compression, or the like). In certain aspects, the request for a ML function configuration may be treated as a request for the association, or vice versa. In certain aspects, the request may be implicit, for example, indirectly indicated via certain signaling from the UE 804. In certain cases, the request may be communicated via UE assistance information, UE capability information, uplink control information, medium access control (MAC) signaling, an on-demand SIB request, or the like.

At 812, the first network entity 802a optionally determines the ML function configuration(s) for the cell(s) served at or by the first network entity 802a. The cell(s) served at or by the first network entity 802a may include source cell(s) and/or serving cell(s) via which the UE 804 may communicate with the first network entity 802a. As an example, the first network entity 802a may determine the cell-specific configuration(s) for the cell(s) served at or by the first network entity 802a, as described herein with respect to FIG. 7, and the cell-specific configuration(s) may indicate or include the ML function configuration(s) and/or the associated ID(s) for the network entity-specific configuration(s). The cell-specific configuration(s) may indicate or include the associated IDs for various network entity-specific configurations and/or various ML functions as described herein with respect to FIG. 7.

At 814, the first network entity 802a sends, to the second network entity 802b, a request for the ML function configuration(s) (and/or the associated IDs) associated with the cells served at or by the second network entity 802b. The cell(s) served at or by the second network entity 802b may include candidate cell(s) and/or target cell(s) via which the UE 804 may communicate with the second network entity 802b. In certain aspects, the first network entity 802a may obtain the ML function configuration(s) (and/or the associated IDs) via access and mobility information and/or Xn message(s).

At 816, the second network entity 802b optionally determines the ML function configuration(s) for the cell(s) served at or by the second network entity 802b, for example, as described herein with respect to the operations at 812.

At 818, the first network entity 802a obtains, from the second network entity 802b, an indication of the ML function configuration(s) for the cell(s) served at or by the second network entity 802b. As an example, the indication of the ML function configurations may be or include the cell-specific configuration(s) for the cell(s) served at or by the second network entity 802b as described herein with respect to FIG. 7. The cell-specific configuration(s) may indicate or include the associated IDs for various network entity-specific configurations and/or various ML functions for the cells of the second network entity 802b.

In certain aspects, the first network entity 802a (e.g., as a CU) may determine the associated IDs and/or ML function configuration (e.g., set of A-beams and set of B-beams) for the second network entity 802b (e.g., as a DU). For example, as a part of backhaul or midhaul link setup (e.g., F1 setup), a CU may obtain, from each of the DU(s) controlled by the CU, a list of cells managed by the respective DU. For each such cell, the DU may provide a reference signal configuration, which may include a list of SSBs transmitted via the respective cells served at or by the DU (e.g., SSB positions in an SSB burst). The CU may generate a data collection configuration (e.g., a data collection CSI resource configuration for the set of A-beams and set of B-beams) and/or inference configuration for each of the candidate, target, neighboring cells of the DU(s). As an example with respect to AI-aided beam prediction, a data collection configuration and/or inference configuration may indicate or include the list of reference signal(s) (such as SSB(s), CSI-RS(s), DMRS(s), and/or the like) to be measured and predicted for each candidate cell and an associated ID for each candidate, target, neighboring cell configuration. The CU may determine a ML function configuration based on a UE measurement report and/or information obtained from DU(s) regarding the transmitting SSBs on the cell. The CU may provide, to the DUs, the respective ML function configurations of the candidate cells and the associated IDs for each of the candidate cells, for example, included in the request at 814.

As an example, the CU may provide, to each the DU(s), a CSI resource configuration that indicates the data collection configuration for each cell and the associated IDs for each candidate cell configuration, for example, included in the request at 814. Each of the DU(s) may generate a CSI report configuration that indicates or includes the associated IDs for each candidate cell based on the CSI resource configuration, and each of the DU(s) may provide the CSI report configuration to the CU, for example, as communicated at 818.

In certain aspects, the second network entity 802b may determine the associated IDs and/or ML function configurations for the second network entity 802b, for example, as described herein with respect to 814. In certain cases, a CU may provide, to the DU, the range of associated IDs to use for ML function configuration association. As an example, the ML function configuration request at 814 may indicate or include the range of associated IDs. The associated ID (for each candidate cell configuration) may be determined by the DU and provided in a data collection configuration (e.g., CSI report configuration). As an example, the associated IDs used by the second network entity 802b may be communicated at 818. The CU may resolve any conflicts with associated IDs among the DUs.

At 820, the UE 804 obtains, from the first network entity 802a, an indication of ML function configuration(s) (such as a data collection configuration and/or an inference operation configuration) and/or the associated ID(s) for the ML function configuration. In certain cases, the ML function configuration(s) (such as a data collection configuration and/or an inference operation configuration) and/or the associated ID(s) may be for cells served at or by the first network entity 802a and/or the second network entity 802b. In certain aspects, the indication of the ML function configuration(s) and/or associated ID(s) may be communicated via a multi-network entity ML configuration as described herein with respect to FIG. 7. The multi-network entity ML configuration may enable the UE 804 to perform AI-aided wireless communications across the coverage areas of multiple network entities, such as the first network entity 802a and the second network entity 802b, with reduced latencies, reduced interruption times, improved accuracy, and/or improved reliability. As an example, the indication of the ML function configuration(s) and/or associated ID(s) may be communicated via RRC signaling (e.g., a CSI report configuration), MAC signaling, downlink control information (DCI), system information, and/or the like.

Note that the process flow illustrated in FIG. 8 is an example of communication of network entity-specific configurations for machine learning training and/or inference, and aspects of the present disclosure may be applied to other suitable signaling. Note that the process flow illustrated in FIG. 8 is described herein to facilitate an understanding of communication of network entity-specific configurations, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of Network Entity-Specific Configurations for Training and Inference

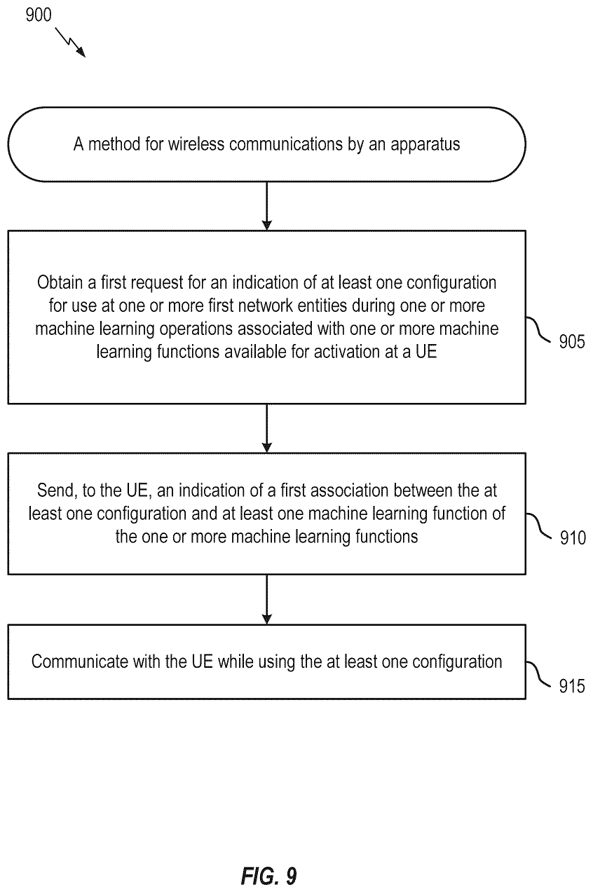

FIG. 9 shows a method 900 for wireless communications by an apparatus, such as BS 102 of FIGS. 1 and 3, or a disaggregated base station as discussed with respect to FIG. 2.

Method 900 begins at block 905 with obtaining a first request for an indication of at least one configuration for use at one or more first network entities during one or more machine learning operations associated with one or more machine learning functions available for activation at a UE, for example, as described herein with respect to FIGS. 7 and 8. In certain aspects, the one or more machine learning operations comprises one or more of: data collection for training of a machine learning model associated with the one or more machine learning functions; or inference operations of the machine learning model. In certain aspects, the at least one machine learning function comprises one or more of: CSI compression; CSI prediction; beam management; or positioning of the UE.

Method 900 then proceeds to block 910 with sending, to the UE, an indication of a first association between the at least one configuration and at least one machine learning function of the one or more machine learning functions, for example, as described herein with respect to FIGS. 7 and 8. The first association may enable the UE to perform AI-aided wireless communications across the coverage area(s) of the one or more first network entities with reduced latencies, reduced interruption times, improved accuracy, and/or improved reliability.

Method 900 then proceeds to block 915 with communicating with the UE while using the at least one configuration, for example, as described herein with respect to FIGS. 7 and 8. For example, the apparatus may apply the at least one configuration while the UE is performing ML model training and/or inference operations.

In certain aspects, the at least one configuration comprises one or more of: a precoding configuration for use at a network entity of the one or more first network entities; an antenna configuration of the network entity; a location of the network entity; an antenna port of the network entity; or an antenna orientation of the network entity.

In certain aspects, sending the first association comprises sending, to the UE, a machine learning configuration for inference operations of the at least one machine learning function, wherein the machine learning configuration indicates the first association.

In certain aspects, block 905 includes obtaining the first request from the UE, wherein the first request is further for one or more data collection configurations associated with the one or more machine learning functions; and block 910 includes sending the one or more data collection configurations that include the indication of the first association. In certain aspects, at least one data collection configuration of the one or more data collection configurations indicates training data for training of a machine learning model associated with a machine learning function of the one or more machine learning functions.

In certain aspects, block 905 includes obtaining the first request from a second network entity (e.g., an AMF, CU, and/or DU), wherein the first request indicates the UE is capable of performing the one or more machine learning functions.

In certain aspects, method 900 further includes obtaining, from the UE, an indication of an identifier associated with the at least one machine learning function (for example, via UE capability information or UE assistance information), wherein the first association is based on the identifier.

In certain aspects, method 900 further includes sending, to the one or more first network entities, a second request for at least one data collection configuration for the at least one machine learning function. In certain aspects, method 900 further includes obtaining, from the one or more first network entities, an indication of the at least one data collection configuration, wherein the first association includes an association between the at least one data collection configuration and the at least one configuration.

In certain aspects, method 900 further includes sending, to the one or more first network entities, a second request for the at least one configuration, and obtain, from the one or more first network entities, an indication of the at least one configuration.

In certain aspects, method 900 further includes obtaining an indication of one or more cells served by the one or more first network entities, and send, to the one or more first network entities, one or more data collection configurations for the one or more cells and an indication of an association between the one or more data collection configurations and the at least one configuration; and block 910 includes sending, to the UE via a network entity of the one or more first network entities, at least one data collection configuration for at least one cell served by the network entity, wherein the at least one data collection configuration includes the indication of the first association.

In certain aspects, method 900 further includes sending, to the one or more first network entities, an indication of the at least one configuration.

In certain aspects, method 900 further includes obtaining, from the one or more first network entities, one or more data collection configurations for one or more cells served by the one or more first network entities and an indication of an association between the one or more data collection configurations and the at least one configuration; and block 910 includes sending, to the UE via a network entity of the one or more first network entities, at least one data collection configuration for at least one cell served by the network entity, wherein the at least one data collection configuration includes the indication of the first association.

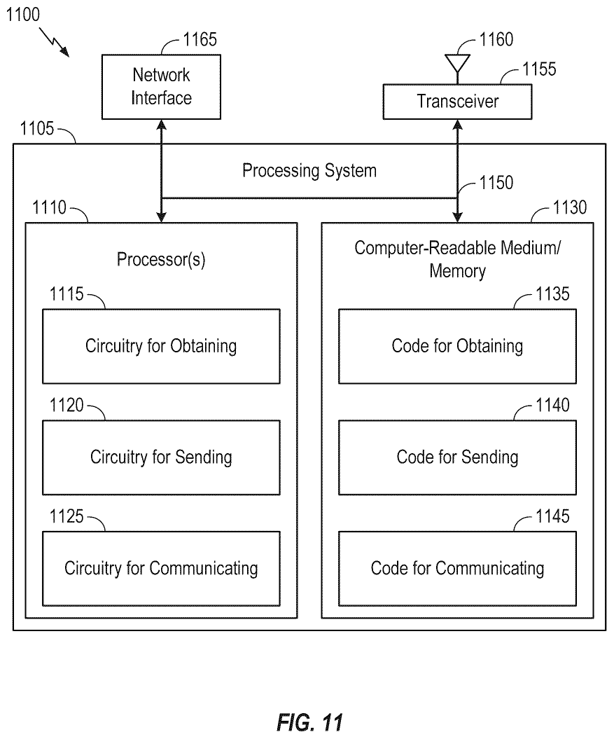

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

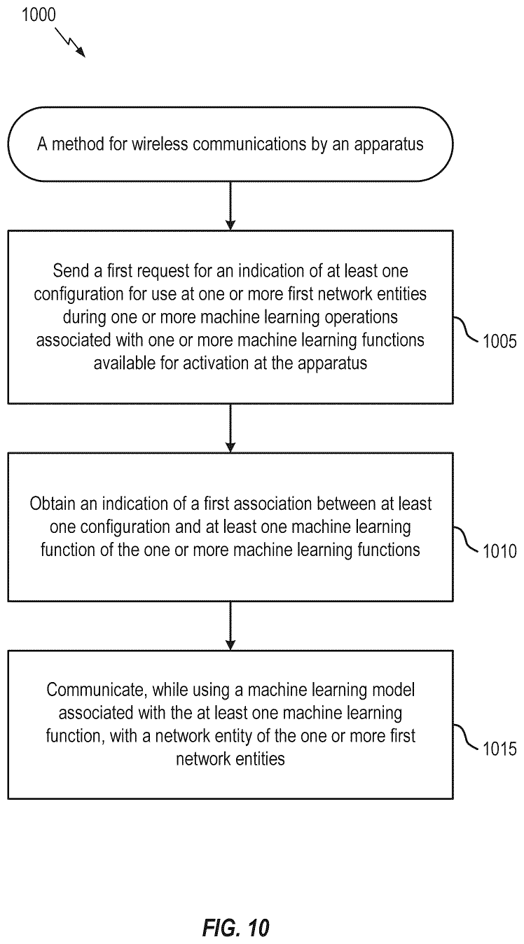

FIG. 10 shows a method 1000 for wireless communications by an apparatus, such as UE 104 of FIGS. 1 and 3.

Method 1000 begins at block 1005 with sending a first request for an indication of at least one configuration for use at one or more first network entities during one or more machine learning operations associated with one or more machine learning functions available for activation at the apparatus, for example, as described herein with respect to FIGS. 7 and 8. In certain aspects, the one or more machine learning operations comprises one or more of: data collection for training of a machine learning model associated with the one or more machine learning functions; or inference operations of the machine learning model. In certain aspects, the at least one machine learning function comprises one or more of: CSI compression; CSI prediction; beam management; or positioning of the apparatus.

Method 1000 then proceeds to block 1010 with obtaining an indication of a first association between at least one configuration and at least one machine learning function of the one or more machine learning functions, for example, as described herein with respect to FIGS. 7 and 8. The first association may enable the apparatus to perform AI-aided wireless communications across the coverage area(s) of the one or more first network entities with reduced latencies, reduced interruption times, improved accuracy, and/or improved reliability.

Method 1000 then proceeds to block 1015 with communicating, while using a machine learning model associated with the at least one machine learning function, with a network entity of the one or more first network entities, for example, as described herein with respect to FIGS. 7 and 8. In certain aspects, block 1015 includes training the machine learning model based on a data collection configuration that indicates the first association. As an example, the first association may ensure that the UE obtains training data for the machine learning model while the network entity is using the at least one configuration.

In certain aspects, method 1000 further includes performing one or more inference operations using the machine learning model based on a machine learning configuration that indicates the first association. As an example, the first association may ensure that the UE performs the one or more inference operations using the machine learning model while the network entity is using the at least one configuration.

In certain aspects, obtaining the first association comprises obtaining a machine learning configuration for inference operations of the at least one machine learning function, wherein the machine learning configuration indicates the first association.

In certain aspects, block 1005 includes sending the first request, wherein the first request is further for one or more data collection configurations associated with the one or more machine learning functions; and block 1010 includes obtaining the one or more data collection configurations that include the indication of the first association.

In certain aspects, at least one data collection configuration of the one or more data collection configurations indicates training data for training of a machine learning model associated with a machine learning function of the one or more machine learning functions.

In certain aspects, method 1000 further includes sending an indication of an identifier associated with the at least one machine learning function, wherein the first association is based on the identifier.

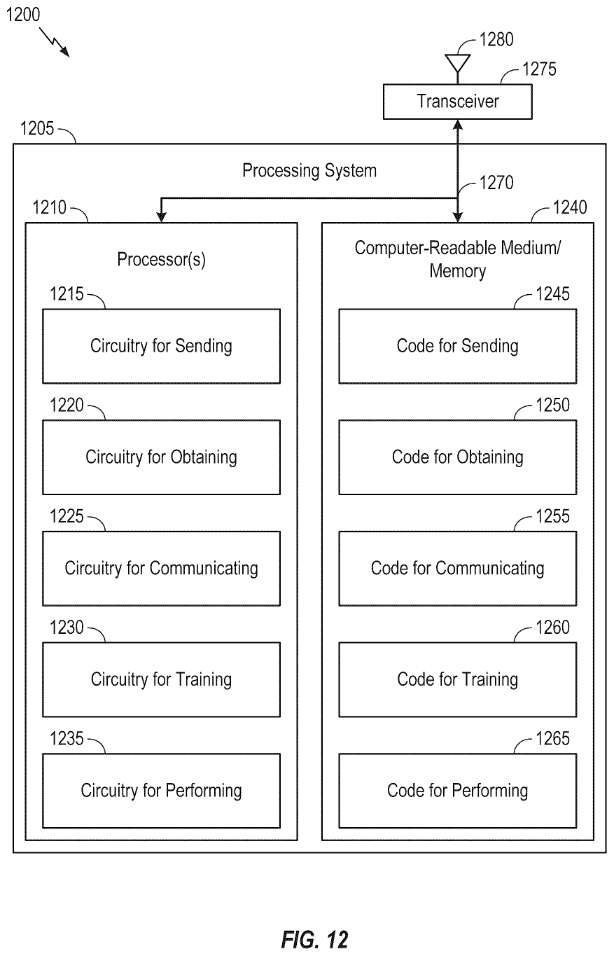

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to a transceiver 1155 (e.g., a transmitter and/or a receiver) and/or a network interface 1165. The transceiver 1155 is configured to transmit and receive signals for the communications device 1100 via an antenna 1160, such as the various signals as described herein. The network interface 1165 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code), including code 1135-1145, that when executed by the one or more processors 1110, enable and cause the one or more processors 1110 to perform the method 900 described with respect to FIG. 9, or any aspect related to it, including any operations described in relation to FIG. 9. Note that reference to a processor of communications device 1100 performing a function may include one or more processors of communications device 1100 performing that function, such as in a distributed fashion.

In the depicted example, the computer-readable medium/memory 1130 stores code for obtaining 1135, code for sending 1140, and code for communicating 1145. Processing of the code 1135-1145 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1130, including circuitry for obtaining 1115, circuitry for sending 1120, and circuitry for communicating 1125. Processing with circuitry 1115-1125 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1155, antenna 1160, and/or network interface 1165 of the communications device 1100 in FIG. 11, and/or one or more processors 1110 of the communications device 1100 in FIG. 11. Means for communicating, receiving or obtaining may include the transceivers 332, antenna(s) 334, receive processor 338, AI processor 318, and/or controller/processor 340 of the BS 102 illustrated in FIG. 3, transceiver 1155, antenna 1160, and/or network interface 1165 of the communications device 1100 in FIG. 11, and/or one or more processors 1110 of the communications device 1100 in FIG. 11.

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1275 (e.g., a transmitter and/or a receiver). The transceiver 1275 is configured to transmit and receive signals for the communications device 1200 via an antenna 1280, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1240 via a bus 1270. In certain aspects, the computer-readable medium/memory 1240 is configured to store instructions (e.g., computer-executable code), including code 1245-1265, that when executed by the one or more processors 1210, enable and cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1240 stores code for sending 1245, code for obtaining 1250, code for communicating 1255, code for training 1260, and code for performing 1265. Processing of the code 1245-1265 may enable and cause the communications device 1200 to perform the method 1000 described with respect to FIG. 10, or any aspect related to it.

The one or more processors 1210 include circuitry configured to implement (e.g., execute) the code (e.g., executable instructions) stored in the computer-readable medium/memory 1240, including circuitry for sending 1215, circuitry for obtaining 1220, circuitry for communicating 1225, circuitry for training 1230, and circuitry for performing 1235. Processing with circuitry 1215-1235 may enable and cause the communications device 1200 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1275 and/or antenna 1280 of the communications device 1200 in FIG. 12, and/or one or more processors 1210 of the communications device 1200 in FIG. 12. Means for communicating, receiving or obtaining may include the transceivers 354, antenna(s) 352, receive processor 358, AI processor 370, and/or controller/processor 380 of the UE 104 illustrated in FIG. 3, transceiver 1275 and/or antenna 1280 of the communications device 1200 in FIG. 12, and/or one or more processors 1210 of the communications device 1200 in FIG. 12. For example, means for training or performing of the method 1000 described with respect to FIG. 10, or any aspect related to it, may include AI processor 370 and/or controller/processor 380 of the UE 104 illustrated in FIG. 3, and/or one or more processors 1210 of the communications device 1200 in FIG. 12

### EXAMPLE CLAUSES

Implementation examples are described in the following numbered clauses:

Clause 1: A method for wireless communications by an apparatus comprising: obtaining a first request for an indication of at least one configuration for use at one or more first network entities during one or more machine learning operations associated with one or more machine learning functions available for activation at a UE; sending, to the UE, an indication of a first association between the at least one configuration and at least one machine learning function of the one or more machine learning functions; and communicating with the UE while using the at least one configuration.

Clause 2: The method of Clause 1, wherein the at least one configuration comprises one or more of: a precoding configuration for use at a network entity of the one or more first network entities; an antenna configuration of the network entity; a location of the network entity; an antenna port of the network entity; or an antenna orientation of the network entity.

Clause 3: The method of any one of Clauses 1-2, wherein the at least one machine learning function comprises one or more of: CSI compression; CSI prediction; beam management; or positioning of the UE.

Clause 4: The method of any one of Clauses 1-3, wherein the one or more machine learning operations comprises one or more of: data collection for training of a machine learning model associated with the one or more machine learning functions; or inference operations of the machine learning model.

Clause 5: The method of any one of Clauses 1-4, wherein sending the first association comprises sending, to the UE, a machine learning configuration for inference operations of the at least one machine learning function, wherein the machine learning configuration indicates the first association.

Clause 6: The method of any one of Clauses 1-5, wherein: obtaining the first request comprises obtaining the first request from the UE, wherein the first request is further for one or more data collection configurations associated with the one or more machine learning functions; and sending the indication of the first association comprises sending the one or more data collection configurations that include the indication of the first association.

Clause 7: The method of Clause 6, wherein at least one data collection configuration of the one or more data collection configurations indicates training data for training of a machine learning model associated with a machine learning function of the one or more machine learning functions.

Clause 8: The method of any one of Clauses 1-7, wherein obtaining the first request comprises obtaining the first request from a second network entity, wherein the first request indicates the UE is capable of performing the one or more machine learning functions.

Clause 9: The method of any one of Clauses 1-8, further comprising obtaining, from the UE, an indication of an identifier associated with the at least one machine learning function, wherein the first association is based on the identifier.

Clause 10: The method of any one of Clauses 1-9, further comprising: sending, to the one or more first network entities, a second request for at least one data collection configuration for the at least one machine learning function; and obtaining, from the one or more first network entities, an indication of the at least one data collection configuration, wherein the first association includes an association between the at least one data collection configuration and the at least one configuration.

Clause 11: The method of any one of Clauses 1-10, further comprising: sending, to the one or more first network entities, a second request for the at least one configuration, and obtain, from the one or more first network entities, an indication of the at least one configuration.

Clause 12: The method of any one of Clauses 1-11, further comprising: obtaining an indication of one or more cells served by the one or more first network entities, and send, to the one or more first network entities, one or more data collection configurations for the one or more cells and an indication of an association between the one or more data collection configurations and the at least one configuration; and sending the indication of the first association comprises sending, to the UE via a network entity of the one or more first network entities, at least one data collection configuration for at least one cell served by the network entity, wherein the at least one data collection configuration includes the indication of the first association.

Clause 13: The method of any one of Clauses 1-12, further comprising: sending, to the one or more first network entities, an indication of the at least one configuration; and obtaining, from the one or more first network entities, one or more data collection configurations for one or more cells served by the one or more first network entities and an indication of an association between the one or more data collection configurations and the at least one configuration; and sending the indication of the first association comprises sending, to the UE via a network entity of the one or more first network entities, at least one data collection configuration for at least one cell served by the network entity, wherein the at least one data collection configuration includes the indication of the first association.

Clause 14: A method for wireless communications by an apparatus comprising: sending a first request for an indication of at least one configuration for use at one or more first network entities during one or more machine learning operations associated with one or more machine learning functions available for activation at the apparatus; obtaining an indication of a first association between at least one configuration and at least one machine learning function of the one or more machine learning functions; and communicating, while using a machine learning model associated with the at least one machine learning function, with a network entity of the one or more first network entities.

Clause 15: The method of Clause 14, wherein communicating with the network entity comprises training the machine learning model based on a data collection configuration that indicates the first association.

Clause 16: The method of any one of Clauses 14-15, further comprising performing one or more inference operations using the machine learning model based on a machine learning configuration that indicates the first association.

Clause 17: The method of any one of Clauses 14-16, wherein the at least one configuration comprises one or more of: a precoding configuration for use at the network entity; an antenna configuration of the network entity; a location of the network entity; an antenna port of the network entity; or an antenna orientation of the network entity.

Clause 18: The method of any one of Clauses 14-17, wherein the at least one machine learning function comprises one or more of: CSI compression; CSI prediction; beam management; or positioning of the apparatus.

Clause 19: The method of any one of Clauses 14-18, wherein the one or more machine learning operations comprises one or more of: data collection for training of a machine learning model associated with the one or more machine learning functions; or inference operations of the machine learning model.

Clause 20: The method of any one of Clauses 14-19, wherein obtaining the first association comprises obtaining a machine learning configuration for inference operations of the at least one machine learning function, wherein the machine learning configuration indicates the first association.

Clause 21: The method of any one of Clauses 14-20, wherein: sending the first request comprises sending the first request, wherein the first request is further for one or more data collection configurations associated with the one or more machine learning functions; and obtaining the indication of the first association comprises obtaining the one or more data collection configurations that include the indication of the first association.

Clause 22: The method of Clause 21, wherein at least one data collection configuration of the one or more data collection configurations indicates training data for training of a machine learning model associated with a machine learning function of the one or more machine learning functions.

Clause 23: The method of any one of Clauses 14-22, further comprising sending an indication of an identifier associated with the at least one machine learning function, wherein the first association is based on the identifier.

Clause 24: One or more apparatuses, comprising: one or more memories comprising executable instructions; and one or more processors configured to execute the executable instructions and cause the one or more apparatuses to perform a method in accordance with any one of Clauses 1-23.

Clause 25: One or more apparatuses, comprising: one or more memories; and one or more processors, coupled to the one or more memories, configured to cause the one or more apparatuses to perform a method in accordance with any one of Clauses 1-23.

Clause 26: One or more apparatuses, comprising: one or more memories; and one or more processors, coupled to the one or more memories, configured to perform a method in accordance with any one of Clauses 1-23.

Clause 27: One or more apparatuses, comprising means for performing a method in accordance with any one of Clauses 1-23.

Clause 28: One or more non-transitory computer-readable media comprising executable instructions that, when executed by one or more processors of one or more apparatuses, cause the one or more apparatuses to perform a method in accordance with any one of Clauses 1-23.

Clause 29: One or more computer program products embodied on one or more computer-readable storage media comprising code for performing a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first request for an indication of at least one configuration for use at one or more first network entities during one or more machine learning operations associated with one or more machine learning functions available for activation at a user equipment (UE);
send, to the UE, an indication of a first association between the at least one configuration and at least one machine learning function of the one or more machine learning functions; and
communicate with the UE while using the at least one configuration.

2. The apparatus of claim 1, wherein the one or more machine learning operations comprises one or more of:
data collection for training of a machine learning model associated with the one or more machine learning functions; or
inference operations of the machine learning model.

3. The apparatus of claim 1, wherein to send the first association, the one or more processors are configured to cause the apparatus to send, to the UE, a machine learning configuration for inference operations of the at least one machine learning function, wherein the machine learning configuration indicates the first association.

4. The apparatus of claim 1, wherein:
to obtain the first request, the one or more processors are configured to cause the apparatus to obtain the first request from the UE, wherein the first request is further for one or more data collection configurations associated with the one or more machine learning functions; and
to send the indication of the first association, the one or more processors are configured to cause the apparatus to send the one or more data collection configurations that include the indication of the first association.

5. The apparatus of claim 4, wherein at least one data collection configuration of the one or more data collection configurations indicates training data for training of a machine learning model associated with a machine learning function of the one or more machine learning functions.

6. The apparatus of claim 1, wherein to obtain the first request, the one or more processors are configured to cause the apparatus to obtain the first request from a second network entity, wherein the first request indicates the UE is capable of performing the one or more machine learning functions.

7. The apparatus of claim 1, wherein the one or more processors are configured to cause the apparatus to obtain, from the UE, an indication of an identifier associated with the at least one machine learning function, wherein the first association is based on the identifier.

8. The apparatus of claim 1, wherein the one or more processors are configured to cause the apparatus to:
send, to the one or more first network entities, a second request for at least one data collection configuration for the at least one machine learning function; and
obtain, from the one or more first network entities, an indication of the at least one data collection configuration, wherein the first association includes an association between the at least one data collection configuration and the at least one configuration.

9. The apparatus of claim 1, wherein the one or more processors are configured to cause the apparatus to:
send, to the one or more first network entities, a second request for the at least one configuration, and
obtain, from the one or more first network entities, an indication of the at least one configuration.

10. The apparatus of claim 1, wherein:
the one or more processors are configured to cause the apparatus to:
obtain an indication of one or more cells served by the one or more first network entities, and
send, to the one or more first network entities, one or more data collection configurations for the one or more cells and an indication of an association between the one or more data collection configurations and the at least one configuration; and
to send the indication of the first association, the one or more processors are configured to cause the apparatus to send, to the UE via a network entity of the one or more first network entities, at least one data collection configuration for at least one cell served by the network entity, wherein the at least one data collection configuration includes the indication of the first association.

11. The apparatus of claim 1, wherein:
the one or more processors are configured to cause the apparatus to:
send, to the one or more first network entities, an indication of the at least one configuration; and
obtain, from the one or more first network entities, one or more data collection configurations for one or more cells served by the one or more first network entities and an indication of an association between the one or more data collection configurations and the at least one configuration; and
to send the indication of the first association, the one or more processors are configured to cause the apparatus to send, to the UE via a network entity of the one or more first network entities, at least one data collection configuration for at least one cell served by the network entity, wherein the at least one data collection configuration includes the indication of the first association.

12. An apparatus configured for wireless communications, comprising:
one or more memories; and
one or more processors coupled to the one or more memories, the one or more processors being configured to cause the apparatus to:
send a first request for an indication of at least one configuration for use at one or more first network entities during one or more machine learning operations associated with one or more machine learning functions available for activation at the apparatus;
obtain an indication of a first association between at least one configuration and at least one machine learning function of the one or more machine learning functions; and
communicate, while using a machine learning model associated with the at least one machine learning function, with a network entity of the one or more first network entities.

13. The apparatus of claim 12, wherein to communicate with the network entity, the one or more processors are configured to cause the apparatus to train the machine learning model based on a data collection configuration that indicates the first association.

14. The apparatus of claim 12, wherein the one or more processors are configured to cause the apparatus to perform one or more inference operations using the machine learning model based on a machine learning configuration that indicates the first association.

15. The apparatus of claim 12, wherein the one or more machine learning operations comprises one or more of:
data collection for training of a machine learning model associated with the one or more machine learning functions; or
inference operations of the machine learning model.

16. The apparatus of claim 12, wherein to obtain the first association, the one or more processors are configured to cause the apparatus to obtain a machine learning configuration for inference operations of the at least one machine learning function, wherein the machine learning configuration indicates the first association.

17. The apparatus of claim 12, wherein:
to send the first request, the one or more processors are configured to cause the apparatus to send the first request, wherein the first request is further for one or more data collection configurations associated with the one or more machine learning functions; and
to obtain the indication of the first association, the one or more processors are configured to cause the apparatus to obtain the one or more data collection configurations that include the indication of the first association.

18. The apparatus of claim 17, wherein at least one data collection configuration of the one or more data collection configurations indicates training data for training of a machine learning model associated with a machine learning function of the one or more machine learning functions.

19. The apparatus of claim 12, wherein the one or more processors are configured to cause the apparatus to send an indication of an identifier associated with the at least one machine learning function, wherein the first association is based on the identifier.

20. A method for wireless communications by an apparatus, comprising:
obtaining a first request for an indication of at least one configuration for use at one or more first network entities during one or more machine learning operations associated with one or more machine learning functions available for activation at a user equipment (UE);
sending, to the UE, an indication of a first association between the at least one configuration and at least one machine learning function of the one or more machine learning functions; and
communicating with the UE while using the at least one configuration.
